(19) United States
(12) Patent Application Publication
(10) Pub. No.: US 2006/0051087 A1
(43) Pub. Date: Mar. 9, 2006

(54) Method for determining the signal-to-noise ratio of an optical signal

(75) Inventors: Jurgen Martin, Aying (DE); Lutz Rapp, Deisenhofen (DE)

Correspondence Address: Siemens Corporation;Intellectual Property Department, 170 Wood Avenue South, Iselin, NJ, 08830, US

(73) Assignee: SIEMENS AKTIENGESELLSCHAFT, MUENCHEN (DE)

(21) Appl. No.: 10/525,612

(22) PCT Filed: Aug. 8, 2003
(86) PCT No.: PCT/DE03/02671

§ 371 Date: Feb. 24, 2005

(30) Foreign Application Priority Data
Aug. 27, 2002 (DE) 102-39-305.2

(51) Int. Cl. H04B 10/08

(52) U.S. Cl. 398/26

(57) ABSTRACT

A method for determining signal-to-noise ratios and noise levels in an optical signal is disclosed, the first polarisation state of which is converted into a second polarisation state by means of number of tunings of a polarisation regulator. Defined changes to the second polarisation state are adjusted on the Poincare sphere by means of the polarisation regulator, whereby power values for the optical signal are determined after selection of a component of the electrical field. Some of the determined power values for the optical signal are stored and serve for the calculation of the signal-to-noise ratio of optical signals. Said method is rapid, requires little complicated equipment and is particularly suitable for a WDM transmission system in which many channels in a WDM signal are transmitted with small channel separations.

### CROSS REFERENCE TO RELATED APPLICATION

This application is the US National Stage of International Application No. PCT/DE2003/002671, filed Aug. 8, 2003 and claims the benefit thereof. The International Application claims the benefits of German Patent application No. 10239305.2 DE filed Aug. 27, 2002, both of the applications are incorporated by reference herein in their entirety.

### FIELD OF THE INVENTION

The invention relates to a method and a device for determining the signal-to-noise ratio (OSNR) of an optical signal according to the preambles of the claims.

### BACKGROUND OF THE INVENTION

The multichannel WDM signal transmission range that can be spanned using wave division multiplex (WDM) transmission systems is limited, among other things, by the amplified spontaneous emission (ASE) produced in optical amplifiers as noise power which is superimposed on the optical signals in the channels. This noise power must be measured for optimum adjustment of the transmission characteristics.

Normally the noise power ASE occurring at a certain wavelength spacing from a channel is measured at smaller and greater wavelengths and the noise power ASE superimposed on the channel is calculated by interpolation. Because of the substantial increase in the number of wavelength channels and the accompanying reduction in channel spacing, this method can no longer be used. In addition, the components used for influencing the spectrum and for coupling signals in and out in modern transmission systems within the route preclude the use of this method. In such transmission systems therefore a method must be used which allows the noise power ASE superimposed on the channels to be measured directly.

To this end a method known as polarization nulling has been proposed which makes use of the fact that the signal portion resulting from the noise component ASE is not polarized. However, the main disadvantage of all hitherto known proposals for implementing this method is that each channel has to be individually selected by spectral filtering and a defined polarization state for optimum suppression of the polarized signal portion must be set using a polarization controller. This method is therefore very complex/costly and results in long measurement times. The two following articles describe the basic principles of the method: “OSNR Monitoring Technique Based on Polarisation Nulling Method”, J. H. Lee, D. K. Jung, C. H. Kim, Y. C. Chung, WEEE Photonics Technology Letters, Vol. 13, No. 1, January 2001; “Improved OSNR Monitoring Technique Based on Polarisation Nulling Method”, J. H. Lee, Y. C. Chung, Electronics Letters, 19^{th} Jul. 2001, Vol. 37, No. 15.

DE 10049769 A1 likewise describes a device and a method for measuring the optical signal-to-noise ratio (OSNR), utilizing the fact that the signal portion, unlike the noise portion, is linearly polarized. After a variable optical bandpass filter (VOBPF) the previously amplified input signal is divided into four subcomponents and the Stokes parameters are determined. A computing equipment calculates both the power of the polarized input signal and the noise power. The ratio of the two provides the OSNR. The device measures the OSNR for the entire spectral range by sequentially varying the passing wavelength of the VOBPF, started with the smaller wavelengths, and determining the peak value for the signal power from the measured power values. Also with this method the equipment complexity is high due to the necessary computing and evaluation unit combined with the filter unit.

In “Optical Signal-To-Noise Ratio Measurement In WDM Networks Using Polarization Extinction”, M. Rasztovits-Wiech et al., ECOC 98, 20-24 September, Madrid, p. 549-550 an arrangement for measuring the signal-to-noise ratio is presented in which a WDM signal is injected into a polarization controller, then into a linear polarizer and subsequently into an optical spectrum analyzer or a power measurement device with preceding tunable optical filter. The tunable filter is set in such a way that the power of an individual channel is completely transmitted and the remaining portion of the WDM spectrum is suppressed. The polarization controller is adjusted until the power meter indicates a minimum signal. The polarizer is then brought into the orthogonal position so that the power measurement device indicates a maximum value. The difference between the maximum signal and the minimum signal increased by 3 dB provides the signal-to-noise ratio OSNR referred to the bandwidth of the tunable filter. One disadvantage of this method is the large amount of time required for measuring a very large number of WDM channels, as all the channels have to be sequentially measured independently as described above.

Another method consists of covering all polarization states on the Poincare sphere using a polarization scrambler and, for each polarization state set, recording an associated spectrum with the aid of an optical spectrum analyzer. The minimum and maximum power determined from analysis of all the recorded spectra is then used for calculating the signal-to-noise ratio OSNR. The minimum power occurs precisely when the signal is completely suppressed by the polarizer, whereas in the case of maximum power the signal power plus the noise power ASE is measured.

U.S. 2001/0052981 A1 discloses a method for measuring the signal-to-noise ratio of an optical signal which constitutes a standard polarization nulling procedure, wherein the rotation angles between a lambda/4 plate and a polarizer are set as manipulated variables by means of a closed-loop control system. A major disadvantage is that a particular polarization state must first be set at the polarizer input. After the polarizer is adjusted, the minimum and maximum of the optical signal are determined from the measurement results. As a control system for 360° rotation of the polarizer is necessary for measuring the signal-to-noise ratios or to achieve one or two required polarization states, this method exhibits a disadvantageous measurement redundancy, making it a time-consuming process.

In practice it is of course impossible to cover all polarization states. A more or less large measurement error remains depending on the number of states selected and the speed at which the polarization state of a channel changes in the transmission system.

### SUMMARY OF THE INVENTION

The object of the invention is to specify a method and a device with which the signal-to-noise ratio of the signals of an optical signal can be determined with minimal complexity and as quickly as possible on the basis of polarization nulling. The method should provide particular advantages for analyzing optical wavelength division multiplex (WDM) signals.

This object is achieved in respect of its method aspect by a method having the features set out in the claims and in respect of its device aspect by a device having the features set out in the claims.

The determined amplitude values of the optical signal are inventively stored on the basis of a method for determining the optical signal-to-noise ratio OSNR of an optical signal having a first polarization state which is converted by means of a plurality of settings of a polarization controller into a second polarization state, whereby defined changes in said second polarization state, for which amplitude values of the optical signal are determined, are set on the Poincare sphere by the polarization controller. The signal-to-noise ratio OSNR of the optical signal or of another optical signal is determined from a calculated value of the stored amplitude values.

According to the invention, the signal-to-noise ratios OSNR of one or more channels are determined by means of interpolation on the basis of a limited number of stored amplitude values. This is achieved by determining the calculated value as an interpolated deviation of the stored amplitude values squared.

A significant advantage of the method according to the invention is that instead of discrete, channel-specific, fine and slow settings or adjustments of the polarization controller, only a few pre-settings for determining amplitude values to be stored are necessary in the case of defined polarization states. This therefore constitutes a very fast method for determining other signal-to-noise ratios OSNR.

A further advantage of the invention is that it is not necessary to set a particular polarization state selectively, so that no complex adjustment is necessary.

As measurements are performed for any polarization states, a plurality of measurement points for all the channels is simultaneously obtained for a given setting of the two plates, so that the measurement time is independent of the number of channels.

Advantageous developments of the invention are set out in the sub-claims.

### BRIEF DESCRIPTION OF THE DRAWING

An exemplary embodiment of the invention will now be explained in further detail with reference to the accompanying drawings in which:

FIG. 1: shows a device for performing the method according to the invention.

### DETAILED DESCRIPTION OF THE INVENTION

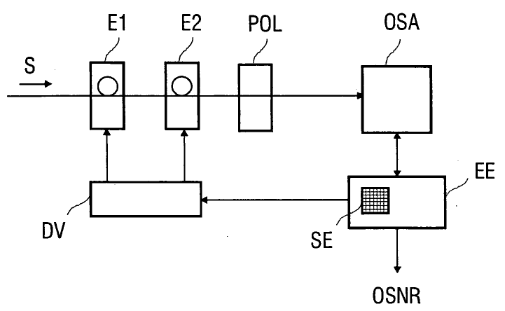

To provide a simpler illustration of the method according to the invention, a device according to FIG. 1 is selected in such a way that a WDM signal S is first fed to a polarization controller PS comprising a λ/4 plate E1 and a λ/2 plate E2 as phase retarder plates. The polarization controller PS is followed by a polarizer POL. For different settings of the polarizer or of the polarization state allowed through from the polarization controller, the spectral power density at the output of this device is recorded in each case by means of an optical spectrum analyzer OSA. The optical spectrum analyzer OSA can be preceded by a wavelength demultiplexer or a wavelength-selective filter, so that selected channels or only one channel of the WDM signal can be recorded. However, demultiplexing is in practice unnecessary. Connected to the optical spectrum analyzer OSA is an optical signal-to-noise ratio (OSNR) determination unit EE in which an interpolation and a deviation search of the amplitude values recorded at the optical spectrum analyzer OSA are performed for determining the measured signal-to-noise ratio OSNR according to the invention. The determination unit EE controls a rotating device DV for the plates E1, E2. Connected to the spectrum analyzer OSA or the determination unit EE is a memory unit SP for tabulating the signal amplitude values measured at the optical spectrum analyzer OSA for different settings of the phase retarder plates E1, E2.

An electrical field vector \vec{E} of a plane wave with frequency ω and wave number k traveling in z-direction in an orthogonal coordinate system with x-, y- and z-axes is described mathematically by the expression:

$${E}^{->} = ( \begin{matrix}{E}_{x} {ⅇ}^{{ⅈφ}_{x}} \\ {E}_{y} {ⅇ}^{{ⅈφ}_{y}}\end{matrix} ) {ⅇ}^{ⅈ ( ω t - kz )}$$

where Eₓ, φₓ and E_{y}, φ_{y} are the amplitude and phase of the components of the electrical field vector \vec{E} in the x- and y-direction respectively. Normalizing to
E=\sqrt{Eₓ²+E_{y}²}
produces the so-called Jones vector \vec{J}:

$${J}^{->} = \frac{1}{E} ( \begin{matrix}{E}_{x} {ⅇ}^{{ⅈφ}_{x}} \\ {E}_{y} {ⅇ}^{{ⅈφ}_{y}}\end{matrix} ) ,$$

which describes the polarization state of the wave.

Only the difference Δφ=φ_{y}−φₓ is of importance for the polarization state, so that the phase of a component may be set to zero. With φₓ=0 we get:

$${J}^{->} = \frac{1}{E} ( \begin{matrix}{E}_{x} \\ {E}_{y} {ⅇ}^{ⅈΔφ}\end{matrix} ) .$$

The effect of optical components on the polarization of a plane wave can be described by Jones matrices which transform the Jones vectors in the form of a linear map. Matrix representations are always linked to the selection of a specific base. This means that when specifying a matrix the position of the coordinate axes is fixed. In this embodiment the x-component of the incoming wave to the linear polarizer POL is subject to maximum transmission and the y-component of this wave is completely suppressed.

The Jones matrix of the λ/4 plate whose fast axis forms the angle δ with the x-axis can be represented as follows:

$${M}_{λ / 4} = \frac{1}{\sqrt{2}} ( \begin{matrix}1 + ⅈ \cdot cos 2 δ & ⅈ \cdot sin 2 δ \\ sin 2 δ & 1 - ⅈ \cdot cos 2 δ\end{matrix} ) .$$

The Jones matrix of the λ/2 plate is of the form:

$${M}_{λ / 2} = ⅈ ( \begin{matrix}cos 2 θ & sin 2 θ \\ sin 2 θ & - cos 2 θ\end{matrix} ) ,$$

where θ denotes the angle between the fast axis of this plate and the x-axis.

The device shown in FIG. 1 will now be considered in the light of this theory. The arrangement comprising the λ/4 plate and the λ/2 plate is described by the following matrix wherein the elements in the second row are intentionally not shown, as they only affect the y-component of the electrical field \vec{E} suppressed by the polarizer POL:

$$M = {M}_{λ / 2} \cdot {M}_{λ / 4} = \frac{ⅈ}{\sqrt{2}} ( \begin{matrix}cos 2 θ + ⅈ \cdot cos ( 2 θ - 2 δ ) & sin 2 θ - ⅈ \cdot sin ( 2 θ - 2 δ ) \\ … & …\end{matrix} )$$

For the signal power I=|\vec{E}|² measured at the optical spectrum analyzer OSA and therefore I=|M·\vec{J}51 ² we obtain:

$$I = \frac{1}{2} [ {E}_{x}^{2} \cdot ( {cos}^{2} 2 θ + {cos}^{2} ( 2 θ - 2 δ ) ) + {E}_{y}^{2} \cdot ( {sin}^{2} 2 θ + {sin}^{2} ( 2 θ - 2 δ ) ) + 2 {E}_{x} {E}_{y} \cdot cos Δφ \cdot ( sin 2 θ \cdot cos 2 θ - sin ( 2 θ - 2 δ ) \cdot cos ( 2 θ - 2 δ ) ) ]$$

where Δφ=φ_{y}−φₓ is as defined above.

In normalized form this yields:

$$\frac{I}{{E}_{x}^{2} + {E}_{y}^{2}} = \frac{1}{2} + cos ( 4 θ - 2 δ ) \cdot [ ( {q}^{2} - 1 / 2 ) \cdot cos 2 δ + q \cdot \sqrt{1 - {q}^{2}} \cdot cos Δφ \cdot cos 2 δ ) ] + sin ( 4 θ - 2 δ ) \cdot q \cdot \sqrt{1 - {q}^{2}} \cdot sin Δφ$$

where q denotes the distribution of the total power to the two components Eₓ, E_{y} at the input of the measurement device according to the following equations:

$${E}_{x} = \frac{q}{\sqrt{{E}_{x}^{2} + {E}_{y}^{2}}} and$$

$${E}_{y} = \frac{\sqrt{1 - {q}^{2}}}{\sqrt{{E}_{x}^{2} + {E}_{y}^{2}}} \cdot {ⅇ}^{ⅈ Δφ}$$

This representation indicates that the dependence of the intensity I on the angle θ can be described by a sinusoidal function sin(4θ−2δ+ρ) (ρ representing a phase which, however, is irrelevant to the present invention).

The square A² of the deviation of this sinusoidal curve—i.e. twice the amplitude—can be calculated as:

$${A}^{2} = 4 \cdot {[ \{ ( {q}^{2} - 1 / 2 ) \cdot cos 2 δ + q \cdot \sqrt{1 - {q}^{2}} \cdot cos Δφ \cdot cos 2 δ ) \}}^{2} + {\{ q \cdot \sqrt{1 - {q}^{2}} \cdot sin Δφ \}}^{2} ]$$

$$or$$

$${A}^{2} = 4 \cdot [ \frac{1}{2} \{ {( {q}^{2} - 1 / 2 )}^{2} + {q}^{2} \cdot ( 1 - {q}^{2} ) \cdot ( 1 + {sin}^{2} Δφ ) \} + \frac{1}{2} \{ {( {q}^{2} - 1 / 2 )}^{2} - {q}^{2} \cdot ( 1 - {q}^{2} ) \cdot {cos}^{2} Δφ \} \cdot cos 4 δ + ( {q}^{2} - 1 / 2 ) \cdot q \cdot \sqrt{1 - {q}^{2}} \cdot cos Δφ \cdot sin 4 δ ]$$

This variable in turn shows a sinusoidal dependence on the angle δ. For the method shown it is significant that the maximum of this variable—irrespective of q and Δφ—is always 1 and therefore gives the signal power.

In short, the invention is based on the knowledge that the power I transmitted by the polarizer POL and measured can be described as a simple trigonometric function dependent on the two setting angles θ and δ of the λ/2 plate and λ/4 plate respectively.

The measured power I at the optical spectrum analyzer OSA is stored for a number of defined settings of the plates E1 and E2 e.g. in a two-dimensional table as a function of the manipulated variables δ and θ. The individual process steps will now be described in detail. To simplify the description, the method will first be discussed for a single channel. It will then be explained how the signal-to-noise ratio OSNR of all channels can be determined simultaneously, e.g. in a WDM system. This method is preferably suitable for any optical multiplex signals prior to demultiplexing.

In the case of a fixed setting of the □/4 plate E1 e.g. at an angle δ1, the power of the channel after the polarizer POL is recorded for n (n=1, 2, . . . N) different settings i.e. for n angles θ1, θ2, . . . , θN of the □/2 plate E2 as a set or spectrum S_{δ1} of power values.

For any permanently selected position of the □/4 plate E1 at other angles δ2, . . . , δM (m=2, . . . (M−1)) and time-constant polarization of the incident light wave, there is sinusoidal dependence between the measured power I after the polarizer POL and the angle θ of the fast axis of the □/2 plate E2 with respect to the polarizer POL. The maximum and the minimum of this curve are dependent on the position of the □/4 plate E1 and will now be denoted as Iₘₐₓ and Iₘᵢₙ respectively.

The powers Iₘₐₓ and Iₘᵢₙ are determined from the measurements for a plurality of positions of the □/2 plate E2 by means of a suitable curve fit to the sine curve and stored, a corresponding deviation A₁ from the powers Iₘₐₓ and Iₘᵢₙ also being stored.

Steps (1) to (3) are now repeated for various positions of the □/4 plate E1 (number m, m>1). M values for Iₘₐₓ and Iₘᵢₙ are therefore determined and stored, further corresponding deviations A₂, A₃, . . . , A_{M} from the powers Iₘₐₓ and Iₘᵢₙ also being stored.

If the square of the difference Iₘₐₓ−Iₘᵢₙ is now plotted above the angle δ for the m positions of the □/4 plate, the maximum value for (Iₘₐₓ−Iₘᵢₙ)² can be determined by a suitable fit to the sinusoidal curve.

The resulting maximum corresponds to the signal power. As the sum of the signal power and noise power is known from a power
measurement at the input of the device, the noise power and therefore also the signal-to-noise ratio OSNR can be determined by subtraction.

The procedure for a multichannel WDM signal is now obvious. Instead of the power of just a single channel, a power spectrum S1, S2, . . . is recorded for each combination of settings of the two birefringent plates E1, E2 so that the powers of all the channels after the polarizer POL are determined in each case. The evaluation by interpolation of the sinusoidal curves can now be performed separately for each channel as before.

1-9. (canceled)

10. A method for determining the signal-to-noise ratio of arbitrarily polarized optical signals of different wavelength that are combined to form a wave division multiplex signal according to a polarization nulling method, comprising:
recording and storing power spectra of the wave division multiplex signal for a first defined setting m=1 (m=1, 2, . . . M) of a first polarization-optical phase controller and for N (n=1, 2, . . . N) settings of a second polarization-optical phase controller;
determining and storing a maximum deviation for the optical signals from the power spectra;
recording and storing the power spectra of the wave division multiplex signal for (M−1) new settings of the first polarization-optical phase controller and for N settings in each case of the second polarization-optical phase controller;
determining and storing from the stored power spectra for each setting of the first phase controller the maximum deviations with m=1, 2 . . . (M−1) of the signals; and
calculating the signal-to-noise ratio for the optical signals based on all of the deviations.

11. The method according to claim 10, wherein the deviation of an optical signal is determined by an interpolation.

12. The method according to claim 10, wherein the signal power of the optical signal is determined by an interpolation of the squared deviations.

13. The method according to claim 10, wherein a sum of the signal and noise power is determined by measuring the power at the input of a polarization controller and a noise power is determined by subtracting a determined signal power of the optical signal.

14. The method according to claim 10, wherein the number of polarization controller settings is selected on a minimum basis depending on a specified relationship between precision determination of the signal-to-noise ratio and measurement time.

15. The method according to claim 10, wherein phase shifts between the components of an electrical field vector of an optical signal and a polarizer are performed by phase retarder plates as polarization-optical phase controllers.

16. The method according to claim 10, wherein a first phase retarder plate can be set using a first rotation angle and a second phase retarder plate can be set using a second rotation angle.

17. The method according to claim 16, wherein the settings of the first and second phase retarder plates and are implemented in such a way that a first phase shift is set for a first rotation angle and a plurality N of angles are set from which a set of N power values is recorded, from these power values a first sinusoidal interpolation curve is determined whose deviation is stored in a table, the settings of the angles are repeated for further rotation angles with m>1 for recording further power values from which further deviations are stored and whose values are squared and interpolated with a sinusoidal curve as a function, and the signal power of the optical signal is determined from the deviation of the sinusoidal curve by the signal-to-noise ratio (OSNR) is derived for the optical signals.

18. The method according to claim 10, wherein a resolution cell with a bandwidth equal to or less than the spectral width of a channel of a WDM signal is selected to record the power values of an optical signal.

19. A device for determining the signal-to-noise ratio of arbitrarily polarized optical signals of different wavelength which are combined to form a WDM signal according to a polarization nulling method, comprising:
a memory unit added to an optical spectrum analyzer for tabulating the power values of the spectra measured at the optical spectrum analyzer for different settings of the phase controllers; and
a determination unit connected to the optical spectrum analyzer for calculating the signal-to-noise ratio by interpolation and deviation searching of the power values recorded at the optical spectrum analyzer,
wherein after passing through a first and a second polarization-optical phase controller the optical signal is injected into a linear polarizer with following optical spectrum analyzer.
